(19) United States
(12) Patent Application Publication
(10) Pub. No.: US 2014/0116943 A1
(43) Pub. Date: May 1, 2014

(54) Water Purification System and Method

(71) Applicant: Keiko Nakano, Tokyo (JP)

(72) Inventor: Keiko Nakano, Tokyo (JP)

(73) Assignee: Hitachi, Ltd., Chiyoda-ku, Tokyo (JP)

(21) Appl. No.: 14/127,057

(22) PCT Filed: May 28, 2012
(86) PCT No.: PCT/JP2012/003451

§ 371 Date: Dec. 17, 2013

(30) Foreign Application Priority Data
Jul. 1, 2011 (JP) 2011-146948

(51) Int. Cl. C02F 9/00

(52) U.S. Cl. CPC C02F 9/00
USPC 210/641; 210/258

(57) ABSTRACT

A water purification system has a closed water channel to circulate circulating water not containing substances causing fouling at the downstream side separated from the water to be treated with a semipermeable membrane. By performing reverse osmosis membrane treatment on the circulating water of a low concentration of organic substances after reclaiming water from the water to be treated containing organic substances to the circulating water through a forward osmosis membrane in which fouling is hard to occur, the substances causing fouling can be prevented from contacting onto the reverse osmosis membrane and thus fouling can be suppressed.

### BACKGROUND

The present invention relates to a purification system for obtaining purified water from seawater, wastewater, or the like.

As background art of the present technical field, there has been one disclosed in JP-A-2010-149123. In this literature, a means is described for “providing a seawater desalination method for desalinating seawater by filtration treatment using a reverse osmosis membrane device, characterized in that seawater is desalinated by performing a mixing step for mixing biologically treated water obtained by treating wastewater containing organic materials biologically as dilution water with seawater having a salt concentration of 1.0 to 8.0 mass %; and a mixed water treating step for supplying the mixed water obtained in said mixing step to the reverse osmosis membrane device for filtration treatment”.

According to this method, the salt concentration is lowered so that pressurization to the reverse osmosis membrane device required in the conventional seawater desalination can be suppressed low and seawater desalination can be performed in an energy saving manner.

In addition, in US 2006/0144789 A1, there is disclosed a method for lowering a salt concentration of seawater using a forward osmosis membrane.

### SUMMARY

In JP-A-2010-149123, it is described to obtain fresh water by diluting seawater with biologically treated water and treating the water after dilution with reverse osmosis membrane treatment. However, in biologically treated water persistent organic substances are contained which remain since organisms cannot completely decompose and a part of the persistent organic substances are adsorbed or deposited onto the reverse osmosis membrane surface, resulting in fouling (clogging).

Once fouling occurs, increase in operating pressure is required to obtain. the same amount of purified water and increases energy consumption for operation. In the case where fouling progresses further, an operating rate of the system decreases for conducting membrane cleaning. Moreover, by repeating cleaning, performance of the membrane salt rejection rate, leading to replacement of the membrane. Due to these, fouling has become a problem of increases in fresh water generation costs (running costs),

In US 2006/0144789 A1, described is a step for lowering the salt concentration of seawater or concentrated water after desalination with wastewater or seawater through a forward osmosis membrane. In this method, while it is capable to prevent substances causing fouling contained in wastewater from flowing into reverse osmosis treatment by separating with the forward osmosis membrane, there has not been taken into consideration on substances causing fouling contained in seawater. Seawater contains metabolites of microorganisms such as plankton or microorganisms which cannot be completely removed in pretreatment, and there is a problem that they cause fouling.

In an aspect of the present invention, it is intended to provide a water purification system in which bringing in substances causing fouling to a reverse osmosis membrane step is suppressed, and thus preventing fouling.

To address the problem described above, configurations described in “What is claimed is” are adopted, for example. The present application contains plural, means for addressing the aforementioned problem and characterized, as an example, by having a flow channel of an aqueous solution, closed by being separated by a semipermeable membrane between water to be treated and a reverse osmosis membrane.

According to the aspect of the present invention, because there is no direct contact between the reverse osmosis membrane and water to be treated which contains a large quantity of substances causing fouling of the reverse osmosis membrane, it is possible to prevent fouling of the reverse osmosis membrane and to reduce fresh water generation costs.

Other objects, features, and advantages of the invention will become apparent from the following description of the embodiments of the invention taken in conjunction with the accompanying drawings.

### BRIEF DESCRIPTION OF THE GRAPHS AND DRAWINGS

FIG. 1 is a block diagram of treatment in a. water purification system according to an exemplary embodiment of the present invention;

FIG. 2 is a block diagram of treatment in a conventional seawater desalination system;

FIG. 3 is a graph showing variations in the concentration of a high osmotic-pressure solution at respective positions in a closed water channel of FIG. 1;

FIG. 4 is a block diagram of treatment in a water purification system of a second embodiment of the present invention; and

FIG. 5 is a graph showing variations in the concentration of a high osmotic-pressure solution at respective positions in a closed water channel of FIG. 4.

### DETAILED DESCRIPTION

Explanation is given below on embodiments according to the present invention with reference to the drawings.

### First Embodiment

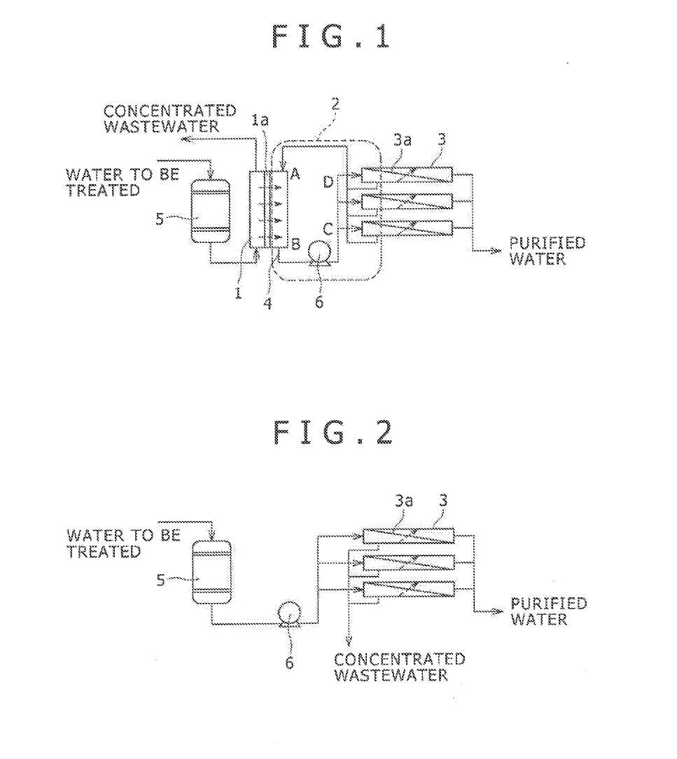

A treatment flow of seawater desalination of the present embodiment is shown in FIG. 1 while a flow of treatment in conventional, seawater desalination is shown in FIG. 2. A difference between FIG. 1 and FIG. 2 is the case of presence and the case of absence of forward osmosis treatment between water to be treated (seawater) after pre-treatment and a reverse osmosis membrane, in the present embodiment, explanation is given on an example of seawater desalination; however, it is not intended to add limitation to the water to be treated, it is applicable to those such as reclamation treatment of wastewater or purified water generation treatment as long as it is a water purification system including reverse osmosis membrane treatment.

FIG. 1. is a schematic diagram of the water treatment system according to the present embodiment. The water treatment system of the present embodiment is provided with a pump 6, a forward osmosis membrane module 1, a reverse osmosis membrane module 3, and a pretreatment equipment 5 and they are mutually connected with water channels. The forward osmosis membrane module 1 has a forward osmosis membrane (a semipermeable membrane) 1a, an inlet and an outlet for to-be-treated water at one side where to-be-treated water flows, and an inlet and an outlet for circulating water at the opposite side where circulating water 4 flows. The reverse osmosis membrane module 3 has a reverse osmosis membrane (a semipermeable membrane) 3a, an inlet and an outlet for circulating water at one side where the circulating water 4 flows, and an outlet of purified water at the opposite side where purified water is taken out.

The pump 6, the reverse osmosis membrane module 3, and the forward osmosis membrane module 1 are connected with water channels. The pump 6 pressurizes the circulating water 4 which passes through the forward osmosis membrane module 1 to send it to the reverse osmosis membrane module 3.

Explanation is now given on operation of the water treatment system of the present embodiment. To-be-treated water (seawater, for example) is treated at the pretreatment equipment 5 and sent to the forward osmosis membrane module 1. In the forward osmosis membrane module 1, to-be-treated water and circulating water are opposed to each other across the forward osmosis membrane 1a, where circulating water has a higher solute concentration than to-be-treated water. Therefore, by osmotic pressure water molecules in the to-be-treated water permeate through a semipermeable membrane 1a and move to a circulating water side. Since the solutes do not move across the forward osmosis membrane 1a, the to-be-treated water is concentrated and discharged as concentrated wastewater.

The circulating water 4 which has passed through the forward osmosis membrane module 1 is pressurized by the pump 6 to be sent to the reverse osmosis membrane module 3.

In the reverse osmosis membrane module 3, the circulating water 4 and purified water are opposed with each other across the reverse osmosis membrane 3a. Since the circulating water 4 has a higher pressure than the purified water, water molecules in the circulating water 4 permeate through the reverse osmosis membrane 3a to become the purified water of an extremely low solute concentration, which is taken out from the water treatment system. Since in the reverse osmosis membrane module 3 water molecules move to the purified water but solutes do not permeate through the semipermeable membrane 3a, the circulating water 4 becomes higher in the concentration and moves to the forward osmosis membrane module 1.

Description is given in detail on processings in respective constituents, in the forward osmosis membrane module 1, a forward osmosis processing is performed. Here, the forward osmosis processing indicates a processing in which water molecules are reclaimed into the circulating water 4 at the downstream side in the directions of the dotted arrows through the forward osmosis membrane 1a by arranging the circulating water 4 of a high osmotic pressure having a higher solute concentration at the downstream side (the circulating water side) than at the upstream. side (the to-be-treated water side) across the semipermeable membrane 1a, which does not let solutes pass but does let only water molecules of a solvent permeate. Because water molecules move using a difference in osmotic pressures, it is a processing which requires no power in theory. Practically, in order to perform movement of water molecules efficiently, the upstream side (the to-be-treated. water side) may be pressurized in some cases.

As the forward. osmosis membrane 1a, one made of cellulose acetate, polyamide, or the like as a primary component is known however, it is not intended to add limitations in material thereof. It is also possible to use a semipermeable membrane commercially available as a. reverse, osmosis membrane for the forward osmosis processing.

As the circulating water 4 disposed at the downstream side of seawater across the forward osmosis membrane 1a, an aqueous solution from which organic substances possibly casing fouling are eliminated from is used. For example, there are aqueous solutions of ionic substances prepared with ultrapure water or the like. As the solutes organic substances, which may become causes of fouling, are suppressed to an extremely low concentration. As the ionic substances monovalent ions are preferable to use to divalent positive ions, which may cause scale; it is not intended to particularly limit thereto, however. Namely, as the circulating water 4 a solution having an extremely low concentration of organic substances and having a high ion concentration is desirable.

Specifically, a solution in which the amount of organic substances is 0.1 mg/L or lower in TOC equivalent and a concentration of ionic substances at the upstream side of the forward osmosis membrane is 2 to 4 times electric charge equivalent of seawater is desirable. When it is not twice or greater, there would be no sufficient difference in osmotic pressures; when it is not four times or less, too high load would be imposed on the reverse osmosis membrane. In the case of a saline solution it would be 6 to 12%; in the case of using another ionic substance, positive charges for monovalent ions (the same amount of negative charges are also present since it is neutral as a whole) are between 1 and 2 mol/L. Namely, when n-valent ions are generated, original ionic substances are dissolved by 1/n to 2/n mol/L. In the present embodiment, an aqueous solution of 10% NACl prepared with ultrapure water providing a sufficient osmotic-pressure difference relative to seawater of a salt concentration of 3.2% is used as the circulating water 4.

A high osmotic-pressure solution 4 is retained in closed water channel 2, separated from upstream and downstream across the forward osmosis membrane 1a at the seawater side and across the reverse osmosis membrane 3a at the reverse osmosis membrane side. By using a semipermeable membrane having high blocking capability of organic substances, the organic substances won't infiltrate into the circulating water 4 from the outside. Since both of the circulating water 4 and the purified water in contact with the reverse osmosis membrane 3a are low in the concentrations of organic substances, fouling is difficult to occur. Moreover, although organic substances are contained in the to-be-treated water, since the to-be-treated water is not pressurized intensively, fouling is difficult to occur on the forward osmosis membrane 1a of the forward osmosis membrane module 1. In addition, even when fouling occurs, the influence thereof on the operating pressure is small since osmosis is driven by a difference in concentrations in the forward osmosis processing.

In the reverse osmosis membrane module 1, a reverse osmosis processing is performed. Here, the reverse osmosis processing indicates a processing in which water molecules in the circulating water 4 are reclaimed into the purified water on the downstream side in the directions of the dotted arrows through the reverse osmosis membrane 3a, in spite of a higher osmotic pressure of the circulating water 4 than that of the purified water by setting pressure at the upstream side (the circulating water side) higher than at the downstream side the purified water side) across the reverse osmosis membrane (semipermeable membrane) 3a, which does not let solutes pass but does let only water molecules of a solvent permeate. Here, in order to move water molecules against the difference in osmotic pressures, power is required. Accordingly, if clogging occurs in the semipermeable membrane 3a, power loss increases; however, in the present embodiment, because the semipermeable membrane 3a is between the circulating water 4 of a low concentration of organic substances and the purified water, fouling is difficult to occur.

In a conventional water treatment system shown. in FIG. 2, since the reverse osmosis membrane 3a is in contact with the to-be-treated water containing organic substances and is positioned on which water pressurized by a pump comes, organic substances in the to-be-treated water adhere onto the reverse osmosis membrane 3a to cause fouling to occur and the power increases during operation.

In the water treatment system of the present embodiment, when seawater was treated by sand filtration and an ultrafiltration membrane to remove foreign elements (insoluble elements) in the solution, soluble organic components of 10 mg/L in TOC equivalent (the amount of total organic carbon) were present in the to-be-treated water. When the to-be-treated water was subjected to the forward osmosis membrane processing, an aqueous solution of 10% NaCl of the circulating water 4 was diluted to 5% and the TOC measured for the circulating water 4 sampled at the vicinity of the forward osmosis membrane 1a was found to be 0.1 mg/L or lower.

Through a reverse osmosis membrane processing of an aqueous solution of 5% NaCl purified water was obtained. However, pump power consumed in the reverse osmosis membrane processing was increased to 8 MPa to secure the amount of permeated water compared to 6 MPa of a conventional power shown in FIG. 2.

Fouling of the reverse osmosis membrane 3a was suppressed and increase in the operating pressure to obtain the same amount of permeated water was not observed for two weeks. On the other hand, the semipermeable membrane surface of the forward osmosis processing, which contacts directly to seawater, was not pressurized and thus fouling substances were not pressed thereon with pressure; the state where fouling was hard to occur was maintained.

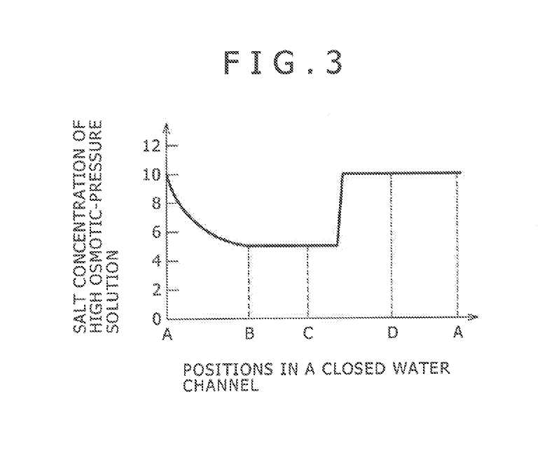

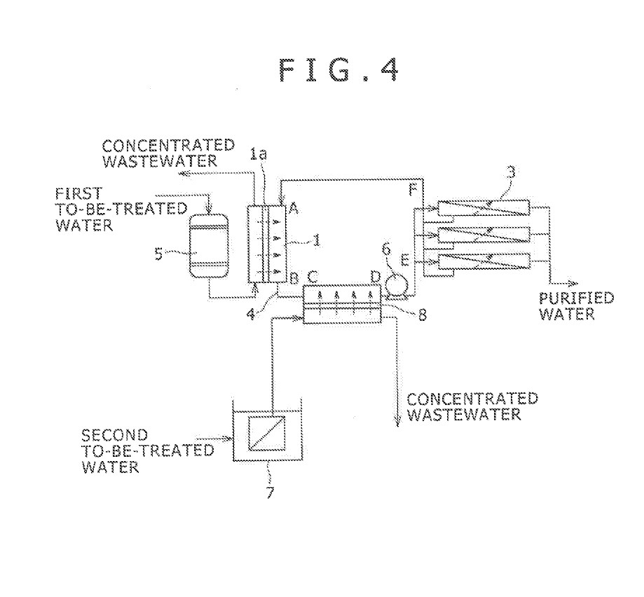

The circulating water was concentrated by the reverse osmosis membrane processing to a concentration of 10% again and sent back toward the side of the forward osmosis membrane module 1. Concentration variations of the high osmotic-pressure solution at respective processing positions are shown in FIG. 3. Here, A to D of the abscissa indicate the positions of A to D in FIG. 1, respectively.

### Second Embodiment

In addition to the first embodiment, a system of a second embodiment is shown in FIG. 4 as a method for obtaining further effects of energy saving and reducing the intake of seawater compared with conventional seawater desalination. Difference from the first embodiment is installment of the plural forward osmosis membrane modules.

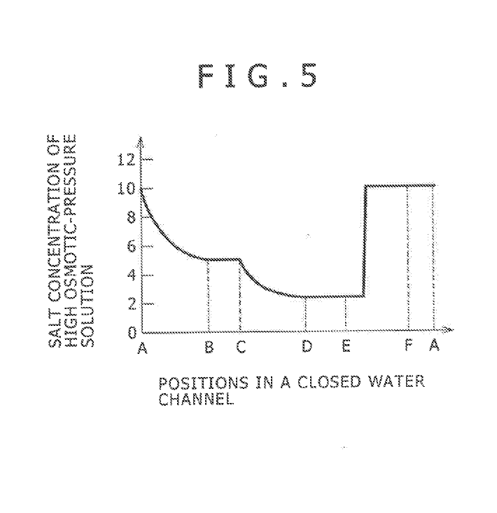

In FIG. 4, similar to in the first embodiment, after obtaining a NaCl solution of 5% concentration by reclaiming water to circulating water 4 from seawater having a salt concentration of 3.2%, which is the first to-be-treated water, via the first forward osmosis membrane module 1, a NaCl solution of 2% concentration is obtained by reclaiming water to the side of the Nail solution of 5% concentration from biologically treated water once stored in a bio reactor 7 (a salt concentration of 0.3%) of wastewater, which is the second to-be-treated water, via the second forward osmosis membrane module 8. Next, purified water is obtained by pressurizing the 2% NaCl solution with the pump 6 and treating with a reverse, osmosis membrane module 3. Here, for convenience, water in a closed water channel in any state is referred to as circulating water. It is returned to the first forward osmosis membrane module 1 after a rate of collection is increased, by performing the reverse osmosis membrane treatment in multiple stages to recover the concentration of the high osmotic pressure solution up to 10%. The variation of the concentration of the circulating water 4 in this case is shown in FIG. 5.

While the amount of organic substances contained in seawater was 10 mg/L in TOC equivalent and the amount of organic substances contained in the biologically treated water was 4 mg/L in TOC equivalent, the TOC amount in. the circulating water was maintained at 0.1 mg/L or lower; further, the effect to fouling of the reverse osmosis membrane was obtained similar to in the first embodiment.

Moreover, while in the conventional method shown in FIG. 2 the operating pressure of the reverse osmotic membrane was 6 MPa, a sufficient amount of permeated water was able to be obtained, at 4 MPa because the high osmotic-pressure solution was diluted to 2% at the vicinity of the reverse osmosis membrane. This obtains effects of enabling seawater desalination that saves more energy than conventional one.

As a further effect, the water intake of seawater and the discharge of the concentrated seawater per unit amount of the fresh water could be reduced. and an effect of mitigating an influence on the environment was also obtained.

In the present embodiment, although biologically treated wastewater was chosen for the second to-be-treated water, river water, well water, primary wastewater of industrial drainage, or the like can be used as long as the salt concentration is equal to or lower than the seawater concentration; even though it is not intended to limit particularly, it is desired the salt concentration of the second treated water is 1% or lower to obtain a sufficient osmotic-pressure difference.

While in the present embodiment two kinds of to-be-treated water were adopted, such a system can also be designed that three or more kinds of to-be-treated water having different osmotic pressures are arranged in the order of high osmotic pressures to recover water via a forward osmosis membrane module.

It should be further understood by those skilled in the art that although the foregoing description has been made on embodiments of the invention, the invention is not limited. thereto and various changes and modifications may he made without departing from the spirit of the invention and the scope of the appended claims.

1. A water purification system for obtaining purified water by treating water to be treated, comprising:
a forward osmosis membrane device for taking in the water to be treated;
a pump;
a reverse osmosis membrane device for taking out the purified water; and
water channels for connecting the forward osmosis membrane device, the pump, and the reverse osmosis membrane device;
wherein there is formed a circulating water channel in which circulating water containing solutes circulates the pump, the reverse osmosis membrane device, and the forward osmosis membrane device in this order; and
wherein the circulating water channel is a closed channel for the solutes of the circulating water.

2. The water purification system according to claim 1,
wherein the reverse osmosis membrane device includes:
an inlet and an outlet for the circulating water, installed at one side of a semipermeable membrane, where the circulating water enters and exits; and
an outlet for the purified water, installed at the opposite side of the semipermeable membrane, where the purified water is taken out, and
wherein the forward osmosis membrane device includes:
an inlet and an outlet for the circulating water, installed at one side of a semipermeable membrane, where the circulating water enters and exits, and
an inlet and an outlet for the water to be treated, installed at the opposite side of the semipermeable membrane, where the water to be treated enters and exits.

3. The water purification system according to claim 1, wherein, as for concentrations of the circulating water, an amount of organic substances is 0.1 mg/L or lower in TOC equivalent, and an ion concentration while moving from the reverse osmosis membrane device to the forward osmosis membrane device is 1 to 2 mol/L in a case of monovalent ions and 1/n to 2/n mol/L in a case of n-valent ions.

4. The water purification system according to claim 1, wherein, as for concentration of the circulating water, an amount of organic substances is 0.1 mg/L or lower in TOC equivalent, and an electric charge equivalent before treatment in the forward osmosis membrane device is 2 to 4 times an electric charge equivalent of the water to be treated before the treatment.

5. The water purification system according to claim 1, wherein any one of water to be treated is seawater.

6. A water purification method for obtaining purified water by treating water to be treated, comprising:
treating with a forward osmosis membrane the water to be treated and a circulating water;
pressurizing the circulating water treated with the forward osmosis membrane with a pump; and
treating with a reverse osmosis membrane the pressurized circulating water,
wherein in the circulating water, a concentration of organic substances is 0.1 mg/L or lower in TOC equivalent, and a concentration of ionic substances is 1 to 2 mol/L in a case of monovalent ions and 1/n to 2/n mol/L in a case of n-valent ions.
